(19) United States
(12) Patent Application Publication
(10) Pub. No.: US 2005/0192724 A1
(43) Pub. Date: Sep. 1, 2005

(54) Method and apparatus for importing weather data from source external to vehicle

(76) Inventor: Jason Hendry, Warren, MI (US)

Correspondence Address: HARNESS, DICKEY & PIERCE, P.L.C., P.O. BOX 828, BLOOMFIELD HILLS, MI, 48303, US

(21) Appl. No.: 10/787,864

(22) Filed: Feb. 26, 2004

(51) Int. Cl. G06F 17/00

(52) U.S. Cl. 701/36; 701/1

(57) ABSTRACT

A method for importing weather data into a motor vehicle for controlling at least one motor vehicle function located therein includes determining a current position of the motor vehicle. Next, weather data based on the current position of the motor vehicle is accessed from a weather data source external to the motor vehicle. At least one motor vehicle function is then controlled based on the weather data.

### FIELD OF THE INVENTION

The present invention relates to receiving weather data in a motor vehicle, and more particularly to an apparatus and method for importing weather data from a source external to the motor vehicle.

### BACKGROUND OF THE INVENTION

It is of great importance in the automobile industry to provide motor vehicles with a comfortable climate within the cabin of the motor vehicle. Accordingly, new automobiles typically include an automated climate control system that automatically adjusts the heating, venting, and air conditioning (HVAC) settings of the motor vehicle. The HVAC settings are calculated from a plurality of factors, including the current interior temperature of the cabin within the motor vehicle, as well as the outside ambient conditions surrounding the motor vehicle.

However, in order to accurately determine the ambient conditions surrounding the motor vehicle, it is necessary to equip the motor vehicle with a plurality of sensors. These sensors typically include an ambient temperature sensor for determining the temperature of the climate surrounding the vehicle and a solar load sensor for determining the amount of sunlight entering the cabin of the motor vehicle. While these sensors are effective for their intended purpose, each sensor used increases the costs, weight, and assembly time of the motor vehicle. Accordingly, there is room in the art for a method and device for automatically calculating HVAC settings without the use of sensors mounted to the motor vehicle.

### SUMMARY OF THE INVENTION

A method for importing weather data into a motor vehicle for controlling at least one motor vehicle function located therein includes determining a current position of the motor vehicle. Next, weather data based on the current position of the motor vehicle is accessed from a weather data source external to the motor vehicle. At least one motor vehicle function is then controlled based on the weather data.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of a control system for importing weather data into a weather importing device according to the principles of the present invention and shown in operative association with an exemplary motor vehicle;

FIG. 2 is a schematic block diagram of the weather importing device of the present invention; and

FIG. 3 is a flowchart illustrating a method of importing weather data from a source external to the motor vehicle according to the principles of the present invention.

### DETAILED DESCRIPTION OF THE PREFERRED EMBODIMENTS

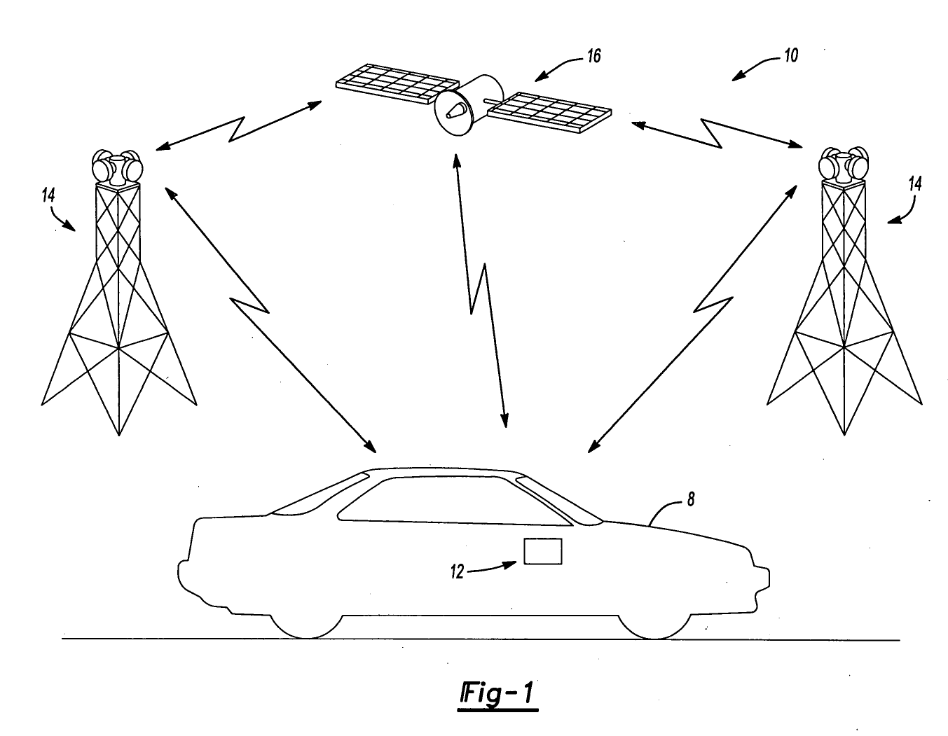

With reference to FIG. 1, a control system 10 is shown in operative association with an exemplary motor vehicle 8 having a weather importing subsystem 12 therein. The weather importing subsystem 12 estimates the ambient conditions surrounding the motor vehicle 8 by receiving weather data from one or more of a plurality of weather data sources 14 that are external to the motor vehicle 8. Using a global positioning system (GPS), the weather importing subsystem 12 communicates with a GPS satellite 16 in order to calculate a current position of the motor vehicle 8. The weather importing subsystem 12 then accesses the weather data source 14 and receives weather data therefrom. In one exemplary embodiment, the weather data source 14 is an internet online weather site capable of providing weather data for a given area based on the current location of the motor vehicle 8. Alternatively, the weather data source 14 comprises a plurality of weather stations. The control system 10 then determines which of a plurality of weather data sources 14 will most accurately estimate the ambient conditions surrounding the motor vehicle 8. In the case that the weather data sources 14 are weather stations, the closest weather data source 14 may be selected and weather data from the selected weather data source 14 will be transmitted to the weather importing subsystem 12. The weather importing subsystem 12 then uses the weather data to automatically adjust the HVAC settings within the motor vehicle 8.

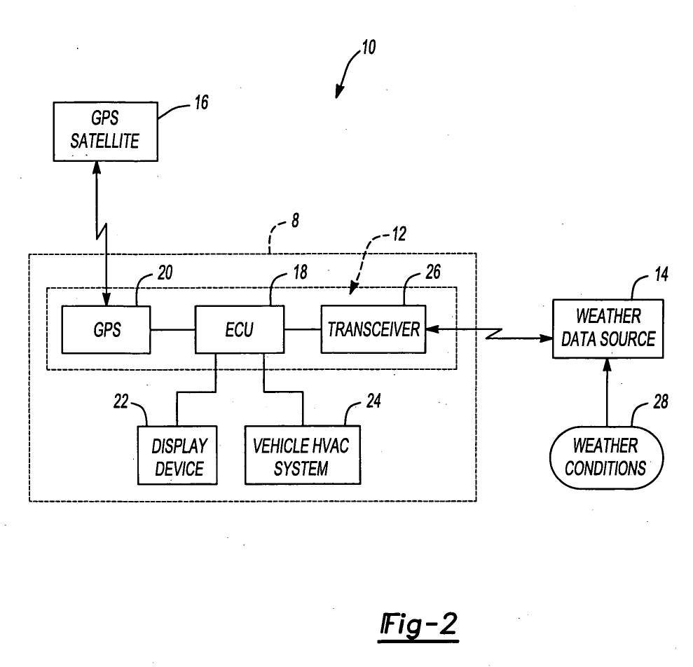

Turning now to FIG. 2, the weather importing subsystem 12 will be described in greater detail. The weather importing subsystem 12 includes an electronic control unit (ECU) 18. The ECU 18 is either a separate control unit or part of the general control unit of the motor vehicle 8. The ECU 18 is in communication with the GPS 20 of the motor vehicle 8 as well as a warning device 22 and a HVAC system 24. The warning device 22 is preferably a display device or user interface having an electronic screen located within the cabin of the motor vehicle 8 capable of displaying text messages and/or providing audible warnings. Alternatively, the warning device 22 may be a radio or any other device capable of providing a warning. The HVAC system 24 is automatically controlled by the ECU 18 and forms part of the climate control system of the motor vehicle 8. The GPS 20 is in wireless communication with the GPS satellite 16. As is known in the art, the GPS 20 is used to determine a current location of the motor vehicle 8. The ECU 18 is adapted to receive the current location of the motor vehicle 8 at any given time from the GPS 20.

The weather importing subsystem 12 further includes a transceiver 26 in communication with the ECU 18. Preferably, the transceiver 26 is a wireless cellular device, such as, for example, an integrated cellular phone system within the motor vehicle 8. However, it should be appreciated that any wireless protocol may be employed such as, for example, a satellite uplink. The transceiver 26 is adapted to wirelessly access the weather data source 14. In a first embodiment, as mentioned above, the transceiver 26 communicates with the weather data source 14 via the internet. Weather conditions 28 are provided by the online internet site used by the control system 10. The weather conditions 28 are supplied using the current location of the motor vehicle 8. For example, the transceiver 26 may use a zip code that the motor vehicle 8 currently is located within (as determined by the GPS 20) to request the weather conditions 28 within the region defined by the zip code.

In a second embodiment, the transceiver 26 is in wireless communication directly with the plurality of weather data sources 14, each of which is comprised of a weather station. These weather stations may be airport weather stations or independently positioned stations. Each weather data source 14 knows and provides weather conditions 28 at the location of the given weather data source 14.

The weather conditions 28 form part of the weather data transmitted directly to the weather importing subsystem 12 and include various weather measurements, such as, for example, temperature, humidity, air pressure, solar conditions, storm warnings, storm watches, tornado warnings, tornado watches, snow conditions, road/ice conditions, and any other relevant weather data.

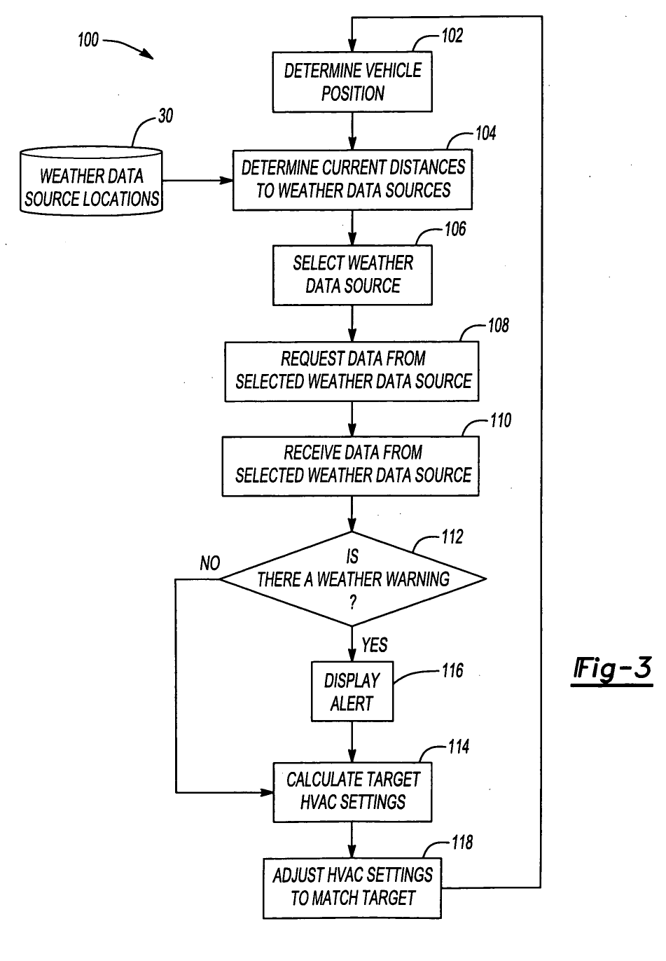

Turning now to FIG. 3, but with continued reference to FIGS. 1 and 2, a method for importing weather data from sources external to the motor vehicle 8 is indicated generally by reference numeral 100. The method 100 specifically addresses communicating directly with weather stations which comprises the weather data sources 14. However, it should be appreciated that the method 100 may also be employed when the weather data source 14 comprises an online internet weather site with no additional steps required. The method 100 begins by determining a current position of the motor vehicle 8 at step 102. The current position of the motor vehicle 8 is received by the ECU 18 via the GPS 20.

The ECU 18 then determines the current distance to the plurality of weather data sources 14 at step 104. Distances to the weather data sources 14 are calculated by comparing the position of the motor vehicle 8, calculated at step 102, to known locations of the weather data sources 14. The locations of the weather data sources 14 are preferably stored within a data store 13 located within the control system 10. Alternatively, the locations of the weather data sources 14 may be transmitted by the GPS satellite 16 to the GPS 20.

At step 106, the ECU 18 selects one or more of the weather data sources 14 to be sources of weather data. Selection of a weather data source 14 is based primarily on location (e.g., which weather data source 14 is closest to the motor vehicle 8). Alternatively, any number of weather data sources 14 may be selected if more than one weather data source 14 is approximately equally distance from the motor vehicle 8. Weather data from these plurality of weather data sources 14 may then be averaged by the ECU 18. In still another embodiment, each weather data source 14 within a certain distance to the motor vehicle 8 is assigned a factor weighted according to how close the weather data source 14 is to the motor vehicle 8. The factor is then used by the ECU 18 to weigh the weather data sent from the weather data source 14 when the weather data is averaged by the ECU 18. As noted above, when the weather data source 14 is an online internet site, the ECU 18 uses the online internet site to receive weather data therefrom and the above mentioned methods of factoring the weather data may be employed. Furthermore, selection of the online weather data site may be based on any number of criteria, such as, for example, cost of use or reliability.

Once one or more weather data sources 14 have been selected, the ECU 18 through the transceiver 26 requests weather data from the selected weather stations at step 108. At step 110, the ECU 18 receives the weather data through the transceiver 26.

At step 112, the ECU 18 determines whether the transmitted weather data includes conditions that are indicative of a driving hazard or includes an explicit weather warning. Conditions indicative of a potentially hazardous driving situation may include a substantial drop in temperature or a substantial drop in air pressure that might indicate wet or frozen pavement. An explicit warning may include a tornado warning or storm warning. If no warning or potentially hazardous conditions exist in the weather data, the method moves on to step 114. If, however, the weather data does contain conditions that are potentially hazardous or contains an explicit weather warning, the ECU 18 activates an alert through the warning device 22 at step 116. This alert may include an audible warning sound and/or include warning text describing the warning on a display. Once the alert has been given, the method 100 moves on to step 114.

At step 114, the ECU 18 calculates target HVAC settings. This is the first step in the ECU 18 controlling a climate control system, which is followed by automatically adjusting the HVAC settings, as will be described below. The target HVAC settings are calculated using the weather data received from the one or more weather data sources 14. For example, a target air outlet temperature corresponding to the temperature of the air to be emitted by the HVAC system 24 may be calculated using the following formula: TAO=Kset*Tset−Kr*Tr−Ka*Tam−Ks*Ts=C, where Tset is Set Temperature, Tr is In Car Temperature, Tam is Outside Air Temperature, Ts is Sun load (W/m2 for 1 min), and Kset, Kr, Kam, Ks are coefficients used commonly in the industry, and C is a constant. As noted above, outside air temperature, sun load and various other factors may be determined using a weighted average from the weather data.

Additionally, the ECU 18 may use the humidity outside of the motor vehicle 8 to adjust the HVAC settings. For example, the humidity may be used by the ECU 18 to determine whether to recirculate the air within the motor vehicle 8 or to pull air from the environment surrounding the motor vehicle 8. Alternatively, the ECU 18 may use the humidity to determine whether to condition the air pulled from outside the motor vehicle 8 (e.g., if the humidity is high outside the motor vehicle 8, the air may be conditioned to lower the humidity to a more comfortable level before entering the cabin of the motor vehicle 8).

Once the target HVAC settings have been calculated, the ECU 18 adjusts the HVAC system 24 to match the target settings at step 118. As a result, the client conditions within the cabin of the motor vehicle 8 will be adjusted to a desired level. This level may either by automatic or manually selected by a user of the motor vehicle 8.

It is to be understood that only the relevant steps of the methodology are discussed in relation to FIG. 3, but that other software-implemented instructions may be needed to control and manage the overall operation of the control system 10.

By eliminating the need for sensors and wiring within the motor vehicle 8, the present invention reduces the weight, cost and complexity of current motor vehicles by employing existing features and technology within a typical motor vehicle 8 to operate the vehicle's HVAC system.

The description of the invention is merely exemplary in nature and, thus, variations that do not depart from the gist of the invention are intended to be within the scope of the invention. Such variations are not to be regarded as a departure from the spirit and scope of the invention.

1. A control system for a motor vehicle, comprising:
a weather data source residing outside of the motor vehicle;
a weather importing subsystem in data communication with the weather data source, the weather importing subsystem operable to determine a current position for the motor vehicle and to access weather data from said weather data source based on the current vehicle position, and adapted to receive said weather data and operable to control at least one vehicle function based on said weather data.

2. The control system of claim 1, wherein said weather data includes air temperature, and said weather importing subsystem uses said air temperature to control a climate control system in the motor vehicle.

3. The control system of claim 1, wherein said weather data includes humidity, and said weather importing subsystem uses said humidity to control a climate control system in the motor vehicle.

4. The control system of claim 3, wherein said weather data subsystem uses said humidity to condition air pulled from outside of the motor vehicle.

5. The control system of claim 1, wherein said weather data includes solar load, and said weather importing subsystem uses said solar load to control a climate control system.

6. The control system of claim 1, wherein the weather importing subsystem further comprises a global positioning system operable to determine said current position of the motor vehicle.

7. The control system of claim 6, wherein the weather importing subsystem further comprises a controller adapted to receive said current position from said global positioning system and operable to select said weather data source based on said current position, and further operable to control at least one function of the motor vehicle based on said set of weather data.

8. The control system of claim 7, wherein the weather importing subsystem further comprises a wireless communication device adapted to receive the selected weather data source from said controller and operable to receive said set of weather data via a wireless communication link from the selected weather data source.

9. The control system of claim 1, wherein the weather importing subsystem further comprises a display device operable to alert a user of the motor vehicle of a weather condition based on said weather data.

10. The control system of claim 1, wherein said weather data source is an online internet weather site.

11. The control system of claim 1, wherein said weather data source is a weather station.

12. A weather importing subsystem in a motor vehicle for importing weather data from a weather data source external to the motor vehicle to operate a climate control system, the weather importing subsystem comprising:
a global positioning system operable to determine a current position of the motor vehicle;
a controller adapted to receive said current position from said global positioning system and operable to select a weather data source based on said current position, and further operable to control at least one function of the motor vehicle based on a set of weather data; and
a wireless communication device adapted to receive the selected weather data source from said controller and operable to receive said set of weather data via a wireless communication link from the selected weather data source.

13. The weather importing subsystem of claim 12, wherein said weather data source is an online internet weather site.

14. The weather importing subsystem of claim 12, wherein said weather data source is a weather station.

15. The weather importing subsystem of claim 14, wherein said controller selects a weather station closest to said current position of the motor vehicle.

16. The weather importing subsystem of claim 14, wherein said controller selects a plurality of weather stations closest to said current position of the motor vehicle, and said controller averages said weather data received from said plurality of weather stations.

17. The weather importing subsystem of claim 14, wherein said controller weights said weather data based on distance to said current position of said motor vehicle.

18. A method for importing weather data into a motor vehicle for controlling at least one motor vehicle function located therein, the method comprising:
determining a current position of the motor vehicle;
accessing weather data based on said current position of the motor vehicle from a weather data source external to the motor vehicle; and
controlling at least one motor vehicle function based on said weather data.

19. The method of claim 18, further comprising determining if said weather data contains a weather warning and alerting a user of the motor vehicle to said weather warning.

20. The method of claim 18, wherein said motor vehicle function is a climate control system.
